(19) United States
(12) Patent Application Publication
(10) Pub. No.: US 2025/0150648 A1
(43) Pub. Date: May 8, 2025

(54) METHOD AND APPARATUS FOR GENERATING VIRTUAL VENUE, DEVICE, MEDIUM, AND PROGRAM PRODUCT

(71) Applicant: Tencent Technology (Shenzhen) Company Limited, Shenzhen (CN)

(72) Inventors: Qi ZHANG, Shenzhen (CN); Weiming LUO, Shenzhen (CN); Huabo NING, Shenzhen (CN); Jin WANG, Shenzhen (CN); Jikai LIN, Shenzhen (CN)

(21) Appl. No.: 19/014,009

(22) Filed: Jan. 8, 2025

Related U.S. Application Data
(63) Continuation of application No. PCT/CN2023/128969, filed on Nov. 1, 2023.

(30) Foreign Application Priority Data
Jan. 19, 2023 (CN) 202310100803.3

(51) Int. Cl. H04N 21/2187; G06T 13/40; G06T 19/20; H04N 21/218

(52) U.S. Cl. CPC H04N 21/2187; G06T 13/40; G06T 19/20; H04N 21/21805; G06T 2219/2004

(57) ABSTRACT

A method for generating a virtual venue includes: constructing a three-dimensional virtual venue including a three-dimensional virtual sandbox and a virtual screening room, the three-dimensional virtual sandbox being a three-dimensional virtual environment in which a virtual object is located, and the virtual screening room for livestreaming a player controlling the virtual object to participate a current competition in the three-dimensional virtual sandbox; dynamically updating a location of the virtual object in the three-dimensional virtual sandbox based on an update to the current competition; generating a first livestreaming video of the virtual object participating the current competition in the three-dimensional virtual sandbox by capturing a three-dimensional field-of-view video of the virtual object in the three-dimensional virtual venue by using a first virtual camera; and playing the first livestreaming video in the virtual screening room and pushing the first livestreaming video to a terminal associated with the virtual screening room.

### CROSS-REFERENCE TO RELATED APPLICATIONS

This application is a continuation application of PCT Patent Application No. PCT/CN2023/128969, entitled “METHOD AND APPARATUS FOR GENERATING VIRTUAL VENUE, DEVICE, MEDIUM, AND PROGRAM PRODUCT” filed on Nov. 1, 2023, which claims priority to Chinese Patent Application No. 202310100803.3, entitled “METHOD AND APPARATUS FOR GENERATING VIRTUAL VENUE, DEVICE, MEDIUM, AND PROGRAM PRODUCT” and filed on Jan. 19, 2023, both of which are incorporated herein by reference in their entirety.

### FIELD OF THE TECHNOLOGY

This application relates to the field of virtual reality technologies, and in particular, to a method and an apparatus for generating a virtual venue, a device, a medium, and a program product.

### BACKGROUND OF THE DISCLOSURE

Nowadays, viewers may pay attention to electronic sports (referred to as “esports” for short) by viewing livestreaming of an electronic-sports competition.

In livestreaming of a conventional esports competition, a broadcast camera is set up at a competition site. A broadcast director controls the broadcast camera to capture a picture from the competition site. Pictures captured in real time are encoded into a video stream, and the video stream is pushed by a stream pushing server to a client. The pictures captured by the broadcast camera are two-dimensional pictures, and after stream pushing, the two-dimensional pictures are duplicated on a two-dimensional screen of a viewer terminal.

The two-dimensional pictures provided in the livestreaming of the conventional esports competition make it difficult for the viewers to have immersive viewing experience. In addition, a location and a shooting angle of the broadcast camera are controlled by the broadcast director, which easily results in a monotonous style of a livestreaming video.

### SUMMARY

This application provides a method and an apparatus for generating a virtual venue, a device, a medium, and a program product. Technical solutions are as follows:

According to an aspect of this application, a method for generating an immersive three-dimensional virtual venue is performed by a computer device and the method including:
constructing a three-dimensional virtual venue, the three-dimensional virtual venue comprising a three-dimensional virtual sandbox and a virtual screening room, the three-dimensional virtual sandbox being a three-dimensional virtual environment in which a virtual object is located, and the virtual screening room being configured for livestreaming a player controlling the virtual object to participate a current competition in the three-dimensional virtual sandbox;
dynamically updating a location of the virtual object in the three-dimensional virtual sandbox based on an update to the current competition;
generating a first livestreaming video of the virtual object participating the current competition in the three-dimensional virtual sandbox by capturing a three-dimensional full field-of-view video of the virtual object in the three-dimensional virtual venue by using a first virtual camera; and
playing the first livestreaming video in the virtual screening room and pushing the first livestreaming video to a terminal associated with a virtual viewer in the virtual screening room.

According to another aspect of this application, a computer device is provided, including: a processor and a memory, the memory having executable instructions stored therein; and the processor being configured to execute the executable instructions in the memory, to implement the method for generating an immersive three-dimensional virtual venue according to the foregoing aspect.

According to another aspect of this application, a non-transitory computer-readable storage medium is provided, having executable instructions stored therein, the executable instructions being loaded and executed by a processor of a computer device to implement the method for generating an immersive three-dimensional virtual venue according to the foregoing aspect.

Beneficial effects brought by the technical solutions provided in this application at least include:

In the method provided in this application, the three-dimensional virtual venue is constructed, and the three-dimensional virtual sandbox and the virtual screening room are constructed in the three-dimensional virtual venue. The three-dimensional virtual environment in which the virtual object is located in the current competition is restored by using the three-dimensional virtual sandbox, and then the location of the virtual object in the current competition is marked on the three-dimensional virtual sandbox. In addition, the event in which the participant player participates in the current competition is livestreamed by using the virtual screening room. The three-dimensional virtual sandbox and the virtual screening room are combined, so that while a participation picture of the participant player is played in the three-dimensional virtual venue, battle information between virtual objects is further displayed on the three-dimensional virtual sandbox. This integrates a scene picture of a real competition into a three-dimensional virtual world, forming mixed reality, thereby achieving an immersive feeling of viewing the competition on site. In addition, the virtual environment and the virtual object in a battle may also be duplicated and restored into the three-dimensional virtual world through virtual modeling, allowing a viewer to see a battle situation of the virtual object more three-dimensionally and vividly, thereby improving efficiency of a user in obtaining location information of the virtual object in the battle in the virtual environment.

### BRIEF DESCRIPTION OF THE DRAWINGS

FIG. 1 is a block diagram of a computer system according to an exemplary embodiment of this application.

FIG. 2 is a flowchart of a method for generating a virtual venue according to an exemplary embodiment of this application.

FIG. 3 is a schematic diagram of a picture in a virtual screening room according to an exemplary embodiment of this application.

FIG. 4 is a schematic diagram of a competition picture of a participant player according to an exemplary embodiment of this application.

FIG. 5 is a schematic diagram of a picture of a virtual waiting room according to an exemplary embodiment of this application.

FIG. 6 is a schematic diagram of a partial picture in a virtual waiting room according to an exemplary embodiment of this application.

FIG. 7 is a schematic diagram of a three-dimensional full field-of-view picture according to an exemplary embodiment of this application.

FIG. 8 is a schematic diagram of a process of livestreaming of a competition according to an exemplary embodiment of this application.

FIG. 9 is a flowchart of a method for livestreaming of a competition according to another exemplary embodiment of this application.

FIG. 10 is a schematic diagram of competition data processing according to an exemplary embodiment of this application.

FIG. 11 is a block diagram of an apparatus for generating a virtual venue according to an exemplary embodiment of this application.

FIG. 12 is a structural block diagram of a computer device according to an exemplary embodiment of this application.

### DESCRIPTION OF EMBODIMENTS

To make objectives, technical solutions, and advantages of this application clearer, the following further describes implementations of this application in detail with reference to the accompanying drawings.

Exemplary embodiments are described in detail herein, and examples thereof are shown in the accompanying drawings. When the following descriptions are made with reference to the accompanying drawings, unless otherwise indicated, the same numbers in different accompanying drawings represent the same or similar elements. Implementations described in the following exemplary embodiments do not represent all implementations that are consistent with this application. On the contrary, the implementations are merely examples of apparatuses and methods that are described in detail in the appended claims and that are consistent with some aspects of this application.

The terms used in this application are for the purpose of describing specific embodiments only and are not intended to limit this application. The singular forms of “a” and “the” used in this application and the appended claims are intended to include the plural forms as well, unless the context clearly indicates otherwise. The term “and/or” used herein indicates and includes any or all possible combinations of one or more associated listed items.

Although terms such as “first” and “second” may be used in this application to describe various information, the information is not to be limited to these terms. These terms are merely used to distinguish between information of the same type. “Several” mentioned in the specification means one or more, and “a plurality of” means two or more. Depending on the context, for example, the word “if” used herein may be interpreted as “while”, “when”, or “in response to”.

First, terms involved in the embodiments of this application are briefly introduced.

Esports competition: It is a competition organized by a competition organizer for a gaming competition. In this application, the esports competition may be a competition organized for any game. The game may be any one of a first-person shooting (FPS) game, a third-person shooting (TPS) game, an MOBA game, a battle arena game, and a simulation game (SLG).

In the game, a participant player may control a virtual object located in a virtual environment to perform activities. The activities of the virtual object include, but are not limited to: at least one of adjusting a body posture, crawling, walking, running, riding, flying, jumping, driving, picking, shooting, attacking, and throwing. The virtual object may be a virtual role. Exemplarily, the virtual object is a virtual character role, such as a simulated character role or a cartoon character role.

In an embodiment, the participant player may perform a competition battle by using a game handle, a smartphone, a laptop computer, a tablet computer, a notebook computer, a desktop computer, a wearable device, a smart watch, an augmented reality (AR) smart device, a virtual reality (VR) smart device, or the like.

Livestreaming scenario of an esports competition: An independent signal collection device is set up at a site of the esports competition to collect audio and video data of the esports competition in real time and import the data into a broadcast directing end (a broadcast directing device or platform). Subsequently, the broadcast directing end publishes, on the Internet through a network, audio and a video of the esports competition collected in real time, for a user to view. For example, the audio and the video are published on a client for the user to view. In some embodiments, gaming battle data provided by a game server of the esports competition is also imported into the broadcast directing end. The broadcast directing end publishes, by visualizing the gaming battle data, the gaming battle data on the Internet for the user to view.

User interface (UI) control: It is any visual control or element that can be seen on a user interface of an application program, for example, a control such as a figure, an input box, a text box, a button, or a label. Some UI controls respond to an operation of a user. For example, the user click/tap a playback control, and this may trigger that a livestreaming video of a live stream of an esports competition and a playback picture of a highlight in the live stream of the esports competition may be displayed in a split-screen manner.

Multiplayer online battle arena (MOBA) game: It is a game in which different virtual teams respectively belonging to at least two opposing camps occupy respective map regions in a virtual environment, and compete against each other with a specific victory condition as a goal. The victory condition includes, but is not limited to: at least one of occupying a fort or destroying a fort of the opposing camp, slaying a virtual object in the opposing camp, ensuring own survival in a specified scenario and moment, seizing a specific resource, and outscoring the opponent within a specified moment. The battle arena game may take place in rounds. The same map or different maps may be used in different rounds of the battle arena game. Each virtual team includes one or more virtual objects, for example, 1 virtual object, 2 virtual objects, 3 virtual objects, or 5 virtual objects.

Virtual environment: It is a virtual environment displayed (or provided) when an application program runs on a terminal. The virtual environment may be a simulated environment of a real world, or may be a semi-simulated and semi-fictional environment, or may be a completely fictional environment. The virtual environment may be any one of a two-dimensional virtual environment, a 2.5-dimensional virtual environment, and a three-dimensional virtual environment. This is not limited in the embodiments of this application.

Virtual object: It is at least one movable object controlled by a user in a virtual environment. The virtual object may be a virtual character, a virtual animal, a cartoon character, or the like. In some embodiments, the virtual object is a three-dimensional spatial model created based on a skeletal animation technology. Each virtual object has a shape and a volume in the virtual environment, and occupies some space in the virtual environment.

In this application, before collection of relevant data of the user and during the collection of the relevant data of the user, a prompt interface or a pop-up window may be displayed, or audio prompt information may be outputted. The prompt interface, the pop-up window, or the audio prompt information is configured for prompting the user that the relevant data of the user is currently searched for collection. In this way, in this application, only after a confirmation operation transmitted by the user for the prompt interface or the pop-up window is obtained, a relevant operation of obtaining the relevant data of the user is started to be performed. Otherwise (in other words, the confirmation operation transmitted by the user for the prompt interface or the pop-up window is not obtained), the relevant operation of obtaining the relevant data of the user is ended, in other words, the relevant data of the user is not obtained. In other words, all user data collected in this application is collected with consent and authorization of the user. In addition, collection, use, and processing of the relevant user data are required to comply with relevant laws, regulations, and standards of relevant countries and regions.

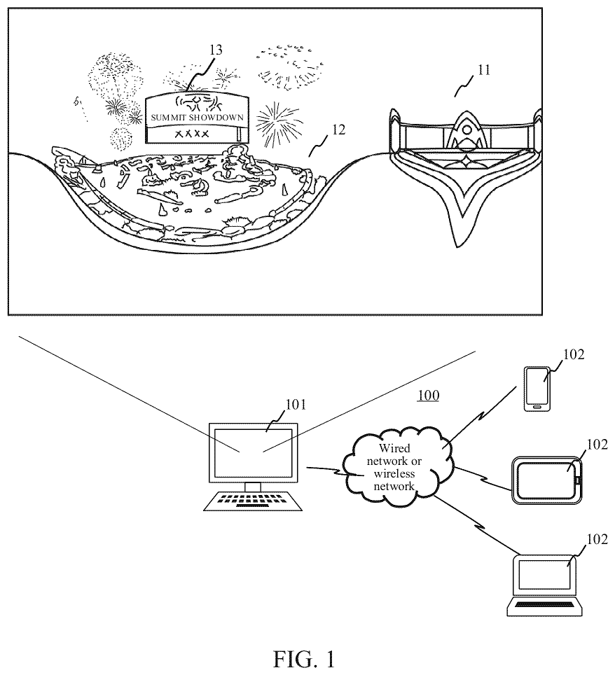

FIG. 1 is a structural block diagram of a computer system 100 according to an exemplary embodiment of this application. The computer system 100 includes: a livestreaming management terminal 101 and a plurality of viewer terminals 102.

An application program supporting a virtual livestreaming room is installed and run on the livestreaming management terminal 101. The virtual livestreaming room is a virtual room run on a livestreaming platform. During pushing of a livestreaming video of a competition in this embodiment of this application, the livestreaming management terminal 101 obtains battle data of a participant player provided by a game server, obtains a picture captured by a camera model in a three-dimensional virtual environment, and generates a picture of the virtual livestreaming room by using an unreal engine (UE). The livestreaming management terminal 101 is a smartphone, a tablet computer, a notebook computer, a desktop computer, a smart television, a wearable device, an in-vehicle terminal, a smart speaker, a smart watch, an AR smart device, a VR smart device, or the like, but is not limited thereto.

The livestreaming management terminal 101 is connected to the plurality of viewer terminals 102 by using a wireless network or a wired network.

The viewer terminal 102 is a terminal configured to view the virtual livestreaming room. An application program supporting a function of viewing a livestream is run on the viewer terminal 102. For example, the application program is a client supporting the function of viewing the livestream, a website page supporting the function of viewing the livestream, or an applet supporting the function of viewing the livestream. In this application, the viewer terminal 102 receives and displays a livestreaming room picture transmitted by the livestreaming management terminal 101. The viewer terminal 102 is a smartphone, a tablet computer, a notebook computer, a desktop computer, a smart television, a wearable device, an in-vehicle terminal, a smart speaker, a smart watch, an AR smart device, a VR smart device, or the like, but is not limited thereto.

With reference to a livestreaming video in FIG. 1, it may be seen that the livestreaming video includes a three-dimensional virtual sandbox 12 and a virtual screening room 11. A virtual screen 13 is further displayed above the three-dimensional virtual sandbox 12, and a competition slogan is displayed on the virtual screen 13. A UE of a game is installed on the livestreaming management terminal 101. The UE fills a real-time picture captured by the camera model into a player container in the virtual screening room, and updates a location of a virtual object on the three-dimensional virtual sandbox in real time based on location data of the virtual object in competition data of a current competition. The livestreaming management terminal 101 transmits the generated livestreaming room picture to the plurality of viewer terminals 102.

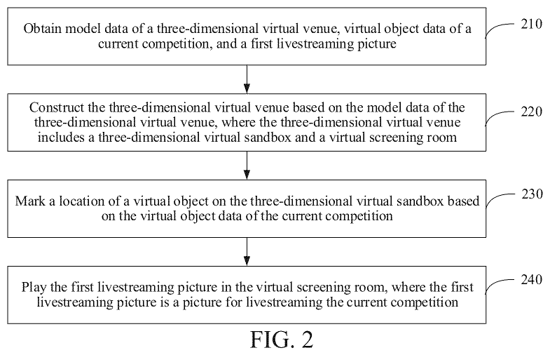

FIG. 2 is a flowchart of a method for generating a virtual venue according to an exemplary embodiment of this application. An example in which the method is performed by a computer device, and the computer device is the livestreaming management terminal 101 shown in FIG. 1 is used for description. The method includes Operation 210, Operation 220, Operation 230, and Operation 240.

Operation 210: Obtain model data of a three-dimensional virtual venue, virtual object data of a current competition, and a first livestreaming video.

The virtual venue is simulation of a real competition venue, or may be a semi-simulated semi-fictional competition venue, or may be an entirely fictional competition venue. The virtual venue may be a 3-dimensional (3D) virtual venue or a pseudo three-dimensional (namely, 2.5-dimensional) virtual venue.

The model data of the three-dimensional virtual venue is configured for constructing a spatial virtual venue. The three-dimensional virtual venue includes a three-dimensional virtual sandbox and a virtual screening room. The three-dimensional virtual sandbox is configured for restoring a three-dimensional virtual environment in which a virtual object is located, and the virtual screening room is configured for livestreaming a competition event of a participant player.

The virtual object data of the current competition is configured for marking a location of the virtual object on the three-dimensional virtual sandbox. In some embodiments, the virtual object data of the current competition includes initial location information of the virtual object in a virtual environment, to be configured for marking an initial location of the virtual object on the three-dimensional virtual sandbox. The virtual environment is an environment provided by an application program for a competition of the virtual object.

In some embodiments, the virtual object data of the current competition further includes at least one of model data of the virtual object of the current competition and identification information of the virtual object. The model data of the virtual object is configured for constructing a three-dimensional image of the virtual object. The identification information of the virtual object is configured for identifying the virtual object, to distinguish different virtual objects. For example, an identifier of the virtual object may be a role name of the virtual object, or an account name corresponding to the virtual object, or an account nickname corresponding to the virtual object, or an avatar of the virtual object, or an account avatar corresponding to the virtual object.

A livestreaming video is a competition picture of the participant player captured in real time. The first livestreaming video is a competition picture of the participant player captured in real time in the current competition. In other words, the first livestreaming video is a picture for livestreaming the current competition. In some embodiments, the first livestreaming video and the virtual object data of the current competition are generated at the same moment.

The livestreaming management terminal obtains the model data of the three-dimensional virtual venue, the virtual object data of the current competition, and the first livestreaming video. Exemplarily, the model data of the three-dimensional virtual venue may be provided by a backend server of the livestreaming management terminal, or provided by an application server. Alternatively, one part of the model data of the three-dimensional virtual venue is provided by a backend server of the livestreaming management terminal, and the other part is provided by an application server. For example, the three-dimensional virtual venue includes a main body structure, the three-dimensional virtual sandbox, and the virtual screening room, where data of the three-dimensional virtual sandbox is provided by a game server, and data of the main body structure and data of the virtual screening room are provided by the backend server of the livestreaming management terminal. The application server is a server, for example, the game server, corresponding to an application supporting a virtual environment.

The three-dimensional virtual venue includes the main body structure, and the main body structure is of a plurality of types, for example, at least one of a vertical space modeling, a curved space modeling, and a circular space modeling. Specifically, the type of the main body structure may be set by using the livestreaming management terminal, and the livestreaming management terminal subsequently obtains data of the main body structure of the set type from the server. The three-dimensional virtual venue includes the virtual screening room, and the virtual screening room may be of a plurality of types, for example, at least one of a giant screen screening room, a laser screening room, and a Dolby screening room. Specifically, the type of the virtual screening room may be set by using the livestreaming management terminal, and the livestreaming management terminal subsequently obtains data of the virtual screening room of the set type from the server.

The three-dimensional virtual venue further includes the three-dimensional virtual sandbox, and the three-dimensional virtual sandbox may be of a plurality of types, for example, at least one of a plain type, a desert type, a mountain type, and a city type. Specifically, the type of the three-dimensional virtual sandbox may be randomly selected by using the application server, or the type of the three-dimensional virtual sandbox may be selected by using a competition terminal. The competition terminal is a terminal used by the participant player in the current competition. The livestreaming management terminal subsequently obtains data of the three-dimensional virtual sandbox of a selected type from the server.

Exemplarily, the virtual object data of the current competition is provided by the application server, for example, the game server.

Exemplarily, the livestreaming video is provided by a livestreaming server. For example, audio and a video of the competition are collected by a signal collection device in real time, and the audio and the video are imported into the livestreaming server for stream pushing. The livestreaming management terminal pulls a stream from the livestreaming server, to obtain the livestreaming video. The signal collection device includes an audio collection device, such as at least one of a mike, a speaker, and a microphone. The signal collection device further includes a video collection device, such as at least one of a camera, a video camera, and a video recorder.

In some embodiments, the competition in this application is an esports competition, and the esports competition is a competition organized by an organizer for electronic sports (or referred to as a gaming competition).

Operation 220: Construct the three-dimensional virtual venue based on the model data of the three-dimensional virtual venue, where the three-dimensional virtual venue includes a three-dimensional virtual sandbox and a virtual screening room.

The three-dimensional virtual sandbox is configured for restoring the three-dimensional virtual environment in which the virtual object is located. Exemplarily, in the esports competition, the three-dimensional virtual sandbox is a spatial structure of movable space of the virtual object in a game displayed in a sandbox form. A two-dimensional (2D) map indicating the movable space of the virtual object exists in the game, and the 3D virtual sandbox may be understood as a 3D map that indicates the movable space of the virtual object and is provided for the livestreaming room. In some embodiments, the 3D virtual sandbox further displays a three-dimensional virtual environment in a battle in a thumbnail form. The 3D virtual sandbox displays a topography of the three-dimensional virtual environment. In some embodiments, the 3D virtual sandbox further displays at least one of an in-game resource point (for example, a neutral creature or a wild monster), a fort (for example, a defense tower), a virtual player role, and a non-player role.

The virtual screening room is configured for livestreaming the competition event of the participant player. In some embodiments, a first player container is arranged in the virtual screening room, and the first player container is configured to play the livestreaming video. The first player container is configured to play a picture of observing the participant player in the competition from a field-of-view of a broadcast director. In some embodiments, a plurality of second player containers are further arranged in the virtual screening room, and the second player container is configured to display an image of the virtual object.

The model data is data needed to be used in three-dimensional modeling. In some embodiments, the model data of the three-dimensional virtual venue includes at least one of model data of the main body structure, model data of the virtual screening room, and model data of the three-dimensional virtual sandbox; and the livestreaming management terminal constructs the main body structure of the three-dimensional virtual venue based on the model data of the main body structure, where the main body structure includes a first carrying region and a second carrying region; constructs the virtual screening room in the first carrying region based on the model data of the virtual screening room; and constructs the three-dimensional virtual sandbox in the second carrying region based on the model data of the three-dimensional virtual sandbox.

The main body structure includes a carrying region. The carrying region is a region in the main body structure configured for bearing and supporting a virtual building, and the carrying region includes the first carrying region and the second carrying region.

Alternatively, the main body structure includes a first central axis and a second central axis; and the livestreaming management terminal uses the first central axis as a central axis of the virtual screening room, and constructs the virtual screening room with reference to the first central axis; and uses the second central axis as a central axis of the three-dimensional virtual sandbox, and constructs the three-dimensional virtual sandbox with reference to the second central axis.

The main body structure includes a central axis, and the central axis is a symmetry axis that passes through a center of the main body structure. The central axis includes the first central axis and the second central axis.

In some embodiments, the virtual screening room and the three-dimensional virtual sandbox are located at different locations of the three-dimensional virtual venue, or the three-dimensional virtual sandbox is located in the virtual screening room.

Exemplarily, there is no overlapping region between the first carrying region and the second carrying region. In other words, the virtual screening room and the three-dimensional virtual sandbox are located in different regions of the three-dimensional virtual venue. For example, as shown in FIG. 1, the virtual screening room 11 is adjacent to the three-dimensional virtual sandbox 12. Alternatively, the second carrying region is located in the first carrying region. In other words, the three-dimensional virtual sandbox is located in the virtual screening room. For example, the three-dimensional virtual sandbox is located below the player container in the virtual screening room.

For construction of the virtual screening room, based on the model data of the virtual screening room, the livestreaming management terminal constructs a three-dimensional model of the virtual screening room in the first carrying region, and generates a model map of the virtual screening room; and pastes the model map of the virtual screening room on the three-dimensional model of the virtual screening room, to obtain the virtual screening room.

For construction of the three-dimensional virtual sandbox, based on the model data of the three-dimensional virtual sandbox, the livestreaming management terminal constructs a three-dimensional model of the three-dimensional virtual sandbox in the second carrying region, and generates a model map of the three-dimensional virtual sandbox; and pastes the model map of the three-dimensional virtual sandbox on the three-dimensional model of the three-dimensional virtual sandbox, to obtain the three-dimensional virtual sandbox.

Operation 230: Mark a location of the virtual object on the three-dimensional virtual sandbox based on the virtual object data of the current competition.

The livestreaming management terminal marks the location of the virtual object on the three-dimensional virtual sandbox based on the virtual object data of the current competition.

In some embodiments, the virtual object data of the current competition includes: at least one of model data of the virtual object and initial location information; and the livestreaming management terminal determines an initial location of the virtual object on the three-dimensional virtual sandbox based on the initial location information; and constructs the virtual object at the initial location based on the model data of the virtual object.

In some embodiments, the initial location information of the virtual object includes three-dimensional location coordinates corresponding to the initial location of the virtual object. Exemplarily, the livestreaming management terminal maps an initial location of the virtual object in the virtual environment onto the three-dimensional virtual sandbox based on initial location information of the virtual object in the virtual environment, to obtain the initial location of the virtual object on the three-dimensional virtual sandbox. Based on the model data of the virtual object, the livestreaming management terminal constructs a three-dimensional model of the virtual object, and generates a model map of the virtual object; and pastes the model map of the virtual object on the three-dimensional model of the virtual object, to obtain a spatial virtual object.

In some embodiments, the virtual object data of the current competition includes: identification information of the virtual object and the initial location information; and the livestreaming management terminal determines an initial location of the virtual object on the three-dimensional virtual sandbox based on the initial location information; and displays an identifier of the virtual object at the initial location based on the identification information of the virtual object.

Exemplarily, the livestreaming management terminal maps the initial location of the virtual object in the virtual environment onto the three-dimensional virtual sandbox based on the initial location information of the virtual object in the virtual environment, to obtain the initial location of the virtual object on the three-dimensional virtual sandbox. The livestreaming management terminal generates the identifier of the virtual object based on the identification information of the virtual object, and displays the foregoing identifier of the virtual object at the foregoing initial location, for example, displays an avatar of the virtual object at the initial location. To distinguish virtual objects of two parties in the battle, the identifier of the virtual object is highlighted by using different frames. For example, different frames are highlighted by using different colors, identifiers of virtual objects of one team are highlighted in blue, and identifiers of virtual objects of another team are highlighted in red.

Operation 240: Play the first livestreaming video in the virtual screening room, where the first livestreaming video is a picture for livestreaming the current competition.

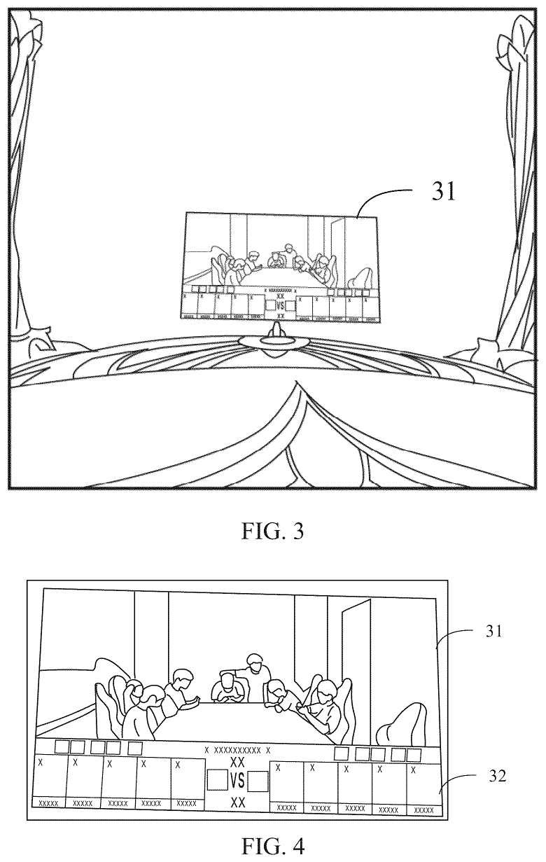

In some embodiments, the first player container is arranged in the virtual screening room; and the livestreaming management terminal fills the first livestreaming video into the first player container in the virtual screening room, to display the first livestreaming video in the first player container. FIG. 3 is a partial schematic diagram of the virtual screening room. A livestreaming video is played in a first player container 31 in the virtual screening room.

In conclusion, in the method for generating a virtual venue provided in the embodiments of this application, the three-dimensional virtual venue is constructed, and the three-dimensional virtual sandbox and the virtual screening room are constructed in the three-dimensional virtual venue. The three-dimensional virtual environment in which the virtual object is located in the current competition is restored by using the three-dimensional virtual sandbox, and then the location of the virtual object in the current competition is marked on the three-dimensional virtual sandbox. In addition, the event in which the participant player participates in the current competition is livestreamed by using the virtual screening room. The three-dimensional virtual sandbox and the virtual screening room are combined, so that while a participation picture of the participant player is played in the three-dimensional virtual venue, battle information between virtual objects is further displayed on the three-dimensional virtual sandbox. This integrates a scene picture of a real competition into a three-dimensional virtual world, forming mixed reality, thereby achieving an immersive feeling of viewing the competition on site. In addition, the virtual environment and the virtual object in a battle may also be duplicated and restored into the three-dimensional virtual world through virtual modeling, allowing a viewer to see a battle situation of the virtual object more three-dimensionally and vividly, thereby improving efficiency of a user in obtaining location information of the virtual object in the battle in the virtual environment.

In some embodiments, at a start moment of the current competition, or before the start moment of the current competition, the three-dimensional virtual venue is constructed, the initial location of the virtual object is mapped onto the three-dimensional virtual sandbox in the three-dimensional virtual venue, and the three-dimensional image of the virtual object is constructed at the initial location. During electronic sports, players respectively control virtual objects thereof to move in the three-dimensional virtual environment, and compete with a goal of achieving a victory condition. The victory condition includes at least one of occupying a fort or destroying a fort of an opposing camp, slaying a virtual object in the opposing camp, ensuring own survival in a specified scenario and moment, seizing a specific resource, and outscoring the opponent within a specified moment. Correspondingly, the livestreaming management terminal obtains competition data during competition, and maps a battle situation in the three-dimensional virtual environment onto the three-dimensional virtual sandbox.

In some embodiments, the competition data is data configured for describing a real-time battle situation during the competition. Specifically, the competition data includes at least one of a real-time location of the virtual object, a hero type, a survival rate, a health value, a win rate, a slaying quantity, a death quantity, an obtained buff or debuff, a piece of obtained or purchased virtual equipment, economic information, equipment information, skill usage, a survival status, and a game picture from a field-of-view of the player.

In some embodiments, the competition data is data configured for describing a target action needed to be performed by the virtual object during the competition. The target action may be an action autonomously selected by the virtual object, or may be a recommended action corresponding to a piece of virtual equipment currently used by the virtual object. For example, if the piece of virtual equipment currently used by the virtual object is a sight, the target action may be an aiming action or an observation action. Specifically, the target action includes at least one of an attack action, a movement action, a performance action, a virtual equipment switch action, and an observation action of the virtual object.

In some embodiments, the competition data is data configured for describing a target movement path corresponding to each virtual object during the competition. The competition data includes at least one of a start point of the target movement path, an end point of the target movement path, a path length, and a location point on the path. The target movement path may be a movement path autonomously selected by the virtual object, or may be a recommended movement path corresponding to a piece of virtual equipment currently used by the virtual object. For example, if the piece of virtual equipment currently used by the virtual object is a virtual smoke bomb, the target movement path is a movement path corresponding to a direction opposite to a smoke diffusion direction of the virtual smoke bomb.

In some embodiments, the competition data is data including each event during the competition. The competition data includes at least one of an event type, an event occurrence moment and an event end moment, and a virtual object included in an event. The event type includes at least one of a slaying event, a defeat event, an attack event, a movement event, and a virtual equipment switch event. Specifically, the defeat event may include at least one of an event in which the virtual object defeats an adversary, or an event in which the virtual object is defeated by an adversary.

In some embodiments, the competition data is data including a facial close-up shot of the participant player controlling the virtual object. An expression of the participant player may be observed by using the competition data. For example, when the virtual object controlled by the participant player defeats the adversary, the participant player may show an expression of joy.

Exemplarily, the livestreaming management terminal obtains competition data of the current competition during the competition; and determines, based on the competition data, a target action needed to be performed by the virtual object, and controls the virtual object to perform the target action on the three-dimensional virtual sandbox, where the target action includes at least one of an attack action, a movement action, a performance action, a virtual equipment switch action, and an observation action of the virtual object.

For example, the target action is a movement action. The livestreaming management terminal determines a target movement path of the virtual object based on the foregoing competition data, and controls the virtual object to move on the three-dimensional virtual sandbox according to the target movement path. For another example, the target action is an attack action. The livestreaming management terminal determines a target attack action, such as a shooting action, a skill casting action, a throwing action, a punching action, or a kicking action, of the virtual object based on the foregoing competition data, and controls the virtual object to perform the target attack action. For another example, the target action is a performance action. The livestreaming management terminal determines a target performance action, such as a dancing action, or a singing action, of the virtual object based on the foregoing competition data, and controls the virtual object to perform the target performance action.

In conclusion, the location of the virtual object on the 3D virtual sandbox is indicated by a 3D role model of the virtual object, and a shape of the 3D role model of the virtual object is consistent with that of the virtual object in the battle. During the current competition, a battle scenario, such as a battle scenario between two opposing parties, in the virtual environment is restored in real time on the three-dimensional virtual sandbox. The 3D role model further has a plurality of representation forms. For example, the 3D role model of the virtual object presents a “running” posture on the sandbox; and the 3D role model of the virtual object presents an “attack” posture on the sandbox. If the virtual object has a long-range attack capability, a “long-range attack” posture (such as an “arrow shooting” posture) is presented; and if the virtual object is a melee virtual role, a “melee attack” posture (such as a “blade wielding” posture) is presented. Alternatively, a scenario special effect in the battle may be restored on the three-dimensional virtual sandbox based on the competition data. For example, after a virtual explosive is triggered on the three-dimensional virtual sandbox, an explosion special effect, such as a special effect of flames and flying debris caused by the explosion, of the virtual explosive is displayed, and a terrain appearance, such as a pothole appearing on a ground, within an attack range of the virtual explosive is updated. For another example, after a virtual smoke bomb is triggered on the three-dimensional virtual sandbox, a smoke special effect within an effect range of the virtual smoke bomb is displayed. By using the three-dimensional virtual sandbox in the method, the battle scenario, such as movement of the virtual object, a battle between virtual objects, and a scenario special effect generated during the battle, in the virtual environment is supported to be restored in real time, to bring the user brand new immersive experience.

In some other embodiments, at a start moment of the current competition, or before the start moment of the current competition, the three-dimensional virtual venue is constructed, the initial location of the virtual object is mapped onto the three-dimensional virtual sandbox in the three-dimensional virtual venue, and the identifier of the virtual object is displayed at the initial location. The identifier of the virtual object on the three-dimensional virtual sandbox may alternatively be referred to as an icon. During electronic sports, players respectively control virtual objects thereof to move in the three-dimensional virtual environment, and compete with a goal of achieving a victory condition. The victory condition includes at least one of occupying a fort or destroying a fort of an opposing camp, slaying a virtual object in the opposing camp, ensuring own survival in a specified scenario and moment, seizing a specific resource, and outscoring the opponent within a specified moment. Correspondingly, the livestreaming management terminal obtains competition data during competition, and maps a location movement situation of the virtual object in the three-dimensional virtual environment onto the three-dimensional virtual sandbox. Exemplarily, the livestreaming management terminal obtains competition data of the current competition during the competition; and determines a target movement path of the virtual object based on the competition data, and controls the identifier of the virtual object to move on the three-dimensional virtual sandbox according to the target movement path.

In conclusion, location movement of the virtual object on the three-dimensional virtual sandbox is indicated by the identifier of the virtual object, and for example, is indicated by an avatar icon. A shape of the avatar icon may be a circle, a triangle, a star, or the like. By using the three-dimensional virtual sandbox in the method, the movement path of the virtual object in the virtual environment is supported to be restored in real time, to bring the user brand new immersive experience. In some embodiments, alternatively, a three-dimensional role model and the identifier of the virtual object may be simultaneously displayed on the three-dimensional virtual sandbox. For example, the identifier of the virtual object is displayed above the three-dimensional role model of the virtual object.

In some other embodiments, the livestreaming management terminal further determines, based on the competition data, at least one of an event in which the virtual object defeats an adversary or an event in which the virtual object is defeated by an adversary; and displays, above the three-dimensional virtual sandbox, at least one of prompt information that the virtual object defeats the adversary, or prompt information that the virtual object is defeated by the adversary. Specifically, the livestreaming management terminal determines, based on the competition data, the event in which the virtual object defeats an adversary, and displays, above the three-dimensional virtual sandbox, the prompt information that the virtual object defeats the adversary. Alternatively, the livestreaming management terminal determines, based on the competition data, the event in which the virtual object is defeated by an adversary, and displays, above the three-dimensional virtual sandbox, the prompt information that the virtual object is defeated by the adversary.

Exemplarily, a virtual screen is further displayed above the three-dimensional virtual sandbox, and each type of prompt information during the competition may be displayed on the virtual screen. For example, at least one of the prompt information that the virtual object is defeated and the prompt information that the virtual object defeats the adversary is displayed on the virtual screen. Alternatively, a comment of a viewer may be displayed on the virtual screen. For example, a classic comment published by the viewer is selected to be displayed on the virtual screen. Exemplarily, as shown in FIG. 1, a virtual screen 13 is displayed above the three-dimensional virtual sandbox 12, and a competition slogan is displayed on the virtual screen 13.

Exemplarily, each type of prompt information during the competition may be presented above the virtual object or above the identifier of the virtual object. Alternatively, the prompt information may be further presented by using the identifier of the virtual object. For example, in any scenario in which the identifier of the virtual object is presented, in response to the virtual object being in a defeated state, the livestreaming management terminal displays the avatar icon of the virtual object in gray on the 3D virtual sandbox. For another example, in response to determining that the virtual object is a virtual object with highest economy in the battle, the avatar icon of the virtual object is highlighted on the 3D virtual sandbox.

In some embodiments, the identifier of the virtual object further carries at least one of the following information: a level value, an experience progress bar, a current economic value, and a remaining health value. For example, an example in which the avatar icon is a circle is used, the level value is displayed at an upper left corner of the avatar icon, the current economic value is displayed at an upper right corner of the avatar icon, and the experience progress bar is displayed by using an outer ring of the avatar icon. For another example, a health bar is displayed above the virtual object or above the identifier of the virtual object, and the health bar is configured for indicating a remaining health value of the virtual object; and the livestreaming management terminal updates a length of the health bar based on the competition data. For example, the length of the health bar is shortened based on a damage value. For another example, the length of the health bar is lengthened based on a healing value.

The 3D virtual sandbox further supports display operations at a plurality of angles and scales. Exemplarily, in response to that the 3D virtual sandbox receives a rotation operation, the livestreaming management terminal displays the 3D virtual sandbox through a plurality of rotation field-of-views. Alternatively, in response to that the 3D virtual sandbox receives a scaling operation, the livestreaming management terminal displays the 3D virtual sandbox through a plurality of scaling degrees.

In response to that the 3D virtual sandbox receives a camp field-of-view switch operation, the livestreaming management terminal displays the 3D virtual sandbox through another camp field-of-view. For example, the 3D virtual sandbox is presented as a 3D map extending from a lower left corner to an upper right corner, and an activity region of the virtual object in the game is symmetrical. Before a camp field-of-view is changed, a base camp of a blue camp is located at a lower left corner of the map, and a base camp of a red camp is located at an upper right corner of the map. After the camp field-of-view is changed, the base camp of the red camp is located at the lower left corner of the map, and the base camp of the blue camp is located at the upper right corner of the map.

The 3D virtual sandbox further supports in displaying a plurality of markers. For example, when a neutral creature is defeated, a marker indicating that the neutral creature has been defeated is displayed on the 3D virtual sandbox. A marker indicating that a neutral creature is to arrive at a battlefield is displayed on the 3D virtual sandbox. A light beam is displayed on the 3D virtual object, to show a special effect when the virtual object is slain. The 3D virtual sandbox presents different situation trends through colors. When an economic difference between the two parties reaches 500, the 3D virtual sandbox is displayed in a green atmosphere. When the economic difference between the two parties reaches 3000, the 3D virtual sandbox is displayed in a yellow atmosphere. When the economic difference between the two parties reaches 5000, the 3D virtual sandbox is displayed in a red atmosphere. A color atmosphere may be understood as an atmosphere formed by using light sources of different colors to illuminate the 3D virtual sandbox.

In conclusion, the 3D virtual sandbox supports each type of prompt information in the battle. The user may effectively obtain battle information in the game from the three-dimensional virtual sandbox, and the three-dimensional virtual sandbox restores the battle scenario in the virtual environment in more detail, so that the user feels more immersed when viewing the competition. In another embodiment, when the prompt information is presented in another manner (other than the manner of being presented by using the virtual screen), a picture of the three-dimensional virtual environment may be presented on the virtual screen. The virtual screen mainly presents a detailed picture of the three-dimensional virtual environment in a fine granularity, and the 3D virtual sandbox presents an overall terrain (mainly configured for presenting the location of the virtual object) of the three-dimensional virtual environment in a coarse granularity. The user may freely select an object to watch, and obtain battle information of different granularities from the 3D virtual sandbox, so that an addition of the 3D virtual sandbox improves efficiency of the user in obtaining the location information of the virtual object. In addition, through the addition of the 3D virtual sandbox, the 3D virtual sandbox supports in restoring a game movement effect in real time, and can more realistically restore a game battle scenario, to bring the user brand new immersive experience.

In some other embodiments, the competition data further includes: at least one of an event in which the virtual object defeats an adversary or an event in which the virtual object is defeated by an adversary, and a facial close-up of the participant player controlling the virtual object; and when the competition data includes the event in which the virtual object defeats an adversary, the livestreaming management terminal generates, based on the facial close-up of the participant player, an expression associated with joy; and displays the expression associated with joy above the virtual object or above the identifier of the virtual object; or when the competition data includes the event in which the virtual object is defeated by an adversary, generates, based on the facial close-up of the participant player, an expression associated with frustration; and displays the expression associated with frustration above the virtual object or above the identifier of the virtual object.

The facial close-up is a local shot that captures a face of the participant player. A participant terminal used by the participant player is equipped with a camera. The application program used in the current competition collects the facial close-up of the participant player in real time by using the camera, and associates the facial close-up with a participant account (namely, an account used by the participant player to control the virtual object). When the event in which the virtual object defeats an adversary or the virtual object is defeated by an adversary occurs, the facial close-up is carried in the competition data and provided to the livestreaming management terminal. The livestreaming management terminal directly displays the facial close-up above the virtual object or above the identifier of the virtual object. Alternatively, when the virtual object is defeated by an adversary, the livestreaming management terminal performs image processing on the facial close-up, and generates an expression figure associated with frustration, a pity, a sigh, or anger. Alternatively, when the virtual object is defeated by an adversary, the livestreaming management terminal generates an expression figure associated with happiness, excitement, or pride. Subsequently, the expression figure is displayed above the virtual object or above the identifier of the virtual object. The virtual object and the facial close-up are associated with the same participant account. Exemplarily, if the expression figure is generated based on the facial close-up, the facial close-up of the participant player may be captured once only.

In some embodiments, the livestreaming management terminal stores a pre-trained image processing model. The image processing model includes at least one of a residual network (ResNet), a graph neural network (GNN), a face identification network (FaceNet). The livestreaming management terminal performs image processing on the facial close-up by using the image processing model. For example, the livestreaming management terminal inputs the facial close-up into the image processing model, extracts an expression feature of the facial close-up by using the image processing model, obtains a corresponding expression type of the facial close-up, and generates an expression figure associated with the expression type. The expression type includes at least one of joy, frustration, anger, a pity, a sigh, pride, excitement, and happiness.

In conclusion, the facial close-up of the participant player is collected, the expression of the participant player when the virtual object is defeated by the adversary or defeats the adversary is displayed. This can better create a competitive atmosphere, and at a critical juncture of defeating the adversary or being defeated by the adversary, the user can focus attention on the three-dimensional virtual sandbox and learn about partial performance of the participant player in the competition through information displayed on the three-dimensional virtual sandbox, without being distracted by the livestreaming video in the virtual screening room.

Exemplarily, when the three-dimensional virtual sandbox is updated based on the competition data, the livestreaming video in the virtual screening room is simultaneously updated. For example, the livestreaming management terminal obtains a second livestreaming video of the current competition during the competition; and switches the first livestreaming video displayed in the first player container to the second livestreaming video, where the first livestreaming video and the second livestreaming video are livestreaming videos played consecutively. In some embodiments, the first livestreaming video and the second livestreaming video may be livestreaming videos played consecutively in different field-of-views in the current competition. For example, the first livestreaming video is a distant picture, and the second livestreaming video is a close picture.

Exemplarily, for the display of the livestreaming video, the livestreaming management terminal may alternatively remove a background of the livestreaming video, and play a livestreaming video obtained after the background is removed in the first player container. The first player container may be placed in the virtual screening room in a floor-standing manner, thereby forming a picture in which the participant player participates in the competition in the virtual screening room.

In some embodiments, at least two second player containers are arranged in the virtual screening room; and the livestreaming management terminal displays an image of a virtual object used by each participant player in each second player container. In other words, an image of one virtual object is displayed in one second player container. The image of the virtual object is a two-dimensional image or a three-dimensional image.

Exemplarily, as shown in FIG. 4, the first player container 31 displays a picture of the participant players during the competition. Ten participant players correspond to ten second player containers 32. In each second player container 32, an image of a virtual object controlled by each participant player is displayed.

In conclusion, when the battle in the virtual environment is restored in the three-dimensional virtual venue, the competition picture of the participant player during the competition is also displayed, so that the user may better know about battle situation in the application program and a battle situation out of the application program.

In some embodiments, a virtual livestreaming room is further created in the livestreaming management terminal, and the virtual livestreaming room is a virtual room that is run on a livestreaming platform and supports livestreaming of a competition. In some embodiments, the virtual livestreaming room is an organizer's livestreaming room (or an official livestreaming room), and the organizer's livestreaming room is available on a plurality of livestreaming platforms. The virtual livestreaming room livestreams a picture captured by a virtual camera.

In some embodiments, a first virtual camera is set up in the three-dimensional virtual venue, and a three-dimensional full field-of-view picture of the three-dimensional virtual venue is captured by using the first virtual camera, to generate a first video stream; and the first video stream is pushed. The three-dimensional full field-of-view picture is a picture captured from the three-dimensional virtual venue within a field-of-view range of a first horizontal angle and a first vertical angle, where the first horizontal angle includes horizontal 360 degrees, and the first vertical angle includes vertical 180 degrees. Alternatively, the three-dimensional full field-of-view picture is a picture captured from the three-dimensional virtual venue within a field-of-view range of a fourth horizontal angle and a fourth vertical angle, where the fourth horizontal angle includes horizontal 360 degrees, and the fourth vertical angle includes vertical 360 degrees.

In some embodiments, a second virtual camera is set up in the three-dimensional virtual venue, and a three-dimensional full field-of-view picture of an event occurring on the three-dimensional virtual sandbox is captured by using the second virtual camera, to generate a second video stream; and the second video stream is pushed. The three-dimensional full field-of-view picture is a picture captured for the event occurring on the three-dimensional virtual sandbox within a field-of-view range of a second horizontal angle and a second vertical angle, where the second horizontal angle includes horizontal 360 degrees, and the second vertical angle includes vertical 180 degrees. Alternatively, the three-dimensional full field-of-view picture is a picture captured for the event occurring on the three-dimensional virtual sandbox within a field-of-view range of a fifth horizontal angle and a fifth vertical angle, where the fifth horizontal angle includes horizontal 360 degrees, and the fifth vertical angle includes vertical 360 degrees.

In some embodiments, a third virtual camera is set up in the three-dimensional virtual venue, and a three-dimensional full field-of-view picture of an event occurring in the virtual screening room is captured by using the third virtual camera, to generate a third video stream; and the third video stream is pushed. The three-dimensional full field-of-view picture is a picture captured from the virtual screening room within a field-of-view range of a third horizontal angle and a third vertical angle, where the third horizontal angle includes horizontal 360 degrees, and the third vertical angle includes vertical 180 degrees. Alternatively, the three-dimensional full field-of-view picture is a picture captured from the virtual screening room within a field-of-view range of a sixth horizontal angle and a sixth vertical angle, where the sixth horizontal angle includes horizontal 360 degrees, and the sixth vertical angle includes vertical 360 degrees.

In other words, the three-dimensional full field-of-view picture is a picture captured within a field-of-view range of horizontal 360 degrees and vertical 180 degrees, or is a picture captured within a field-of-view range of horizontal 360 degrees and vertical 360 degrees.

Exemplarily, the virtual livestreaming room includes a first virtual livestreaming room, a second virtual livestreaming room, and a third virtual livestreaming room. The first video stream is played in the first virtual livestreaming room, the second video stream is played in the second virtual livestreaming room, and the third video stream is played in the third virtual livestreaming room. The user may enter the first virtual livestreaming room, to view a full picture in the three-dimensional virtual venue. Alternatively, the user may enter the second virtual livestreaming room, to view a battle picture on the three-dimensional virtual sandbox. Alternatively, the user may enter the third virtual livestreaming room, to view a competition picture in the virtual screening room.

In conclusion, the livestreaming management terminal pushes a live stream to a viewer terminal. The user can view the three-dimensional full field-of-view picture of the three-dimensional virtual venue, the three-dimensional full field-of-view picture of the three-dimensional virtual sandbox, or the three-dimensional full field-of-view picture of the virtual screening room on the viewer terminal, so that the user can autonomously select a picture to view when viewing livestreaming of the competition, and can feel as if the user is in the competition.

In some other embodiments, before the current competition starts, the livestreaming management terminal further obtains model data of a virtual waiting room; and constructs a three-dimensional virtual waiting room based on the model data of the virtual waiting room.

The virtual waiting room is a virtual room in which the user waits for a start of livestreaming. Exemplarily, the livestreaming management terminal generates a three-dimensional model of the virtual waiting room and a map of the virtual waiting room based on the model data of the virtual waiting room; and pastes the map of the virtual waiting room on the three-dimensional model of the virtual waiting room, to obtain a spatial virtual waiting room. A three-dimensional full field-of-view picture of a scenario in the virtual waiting room is captured by using a virtual camera, to generate a fourth video stream, and the stream is pushed to the viewer terminal. The three-dimensional full field-of-view picture is a picture captured from the virtual waiting room within a field-of-view range of a seventh horizontal angle and a seventh vertical angle, where the seventh horizontal angle includes horizontal 360 degrees, and the seventh vertical angle includes vertical 180 degrees. Alternatively, the three-dimensional full field-of-view picture is a picture captured from the virtual waiting room within a field-of-view range of an eighth horizontal angle and an eighth vertical angle, where the eighth horizontal angle includes horizontal 360 degrees, and the eighth vertical angle includes vertical 360 degrees.

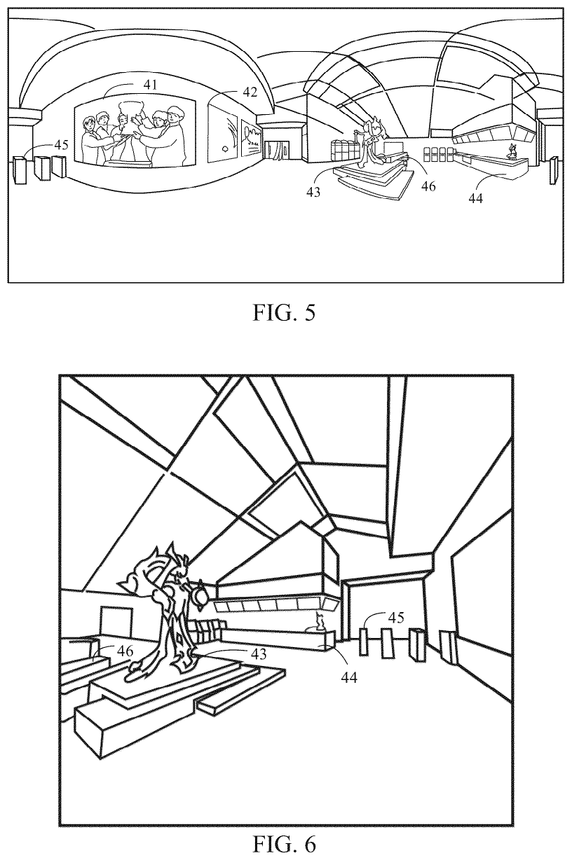

FIG. 5 shows a schematic diagram of a virtual waiting room. The virtual waiting room includes a group photo 41 of players, a brief introduction 42, a model display 43 of a virtual object, snack and beverage vending room 44, entry and exit gates 45, lounge seating 46, and the like. FIG. 6 shows a local rendering effect of the virtual waiting room in an observation angle different from an observation angle in FIG. 5.

In conclusion, the viewer enters the virtual waiting room before the current competition starts, and then enters the three-dimensional virtual venue from the virtual waiting room when the competition starts. From waiting to entering the venue and then to the start of the competition, the viewer can experience a more realistic competition viewing scenario.

The following is an overall description of a virtual venue display method performed by the livestreaming management terminal 101 and the viewer terminal 102.

Exemplarily, an application program supporting the virtual livestreaming room is installed and run on the livestreaming management terminal 101. During livestreaming of the competition, the livestreaming management terminal 101 performs the virtual venue display method, and a process is as follows:

(1) Obtain model data of a three-dimensional virtual venue, virtual object data of a current competition, and a first livestreaming video.

The livestreaming management terminal 101 obtains the model data of the three-dimensional virtual venue, the virtual object data of the current competition, and the first livestreaming video. The first livestreaming video is a picture for livestreaming the current competition.

In some embodiments, the model data of the three-dimensional virtual venue includes at least one of model data of a main body structure, model data of a virtual screening room, and model data of a three-dimensional virtual sandbox. The virtual object data of the current competition includes: at least one of model data of a virtual object, identification information of the virtual object, and initial location information.

(2) Construct the three-dimensional virtual venue based on the model data of the three-dimensional virtual venue, where the three-dimensional virtual venue includes the three-dimensional virtual sandbox and the virtual screening room.

The livestreaming management terminal 101 constructs the main body structure of the three-dimensional virtual venue based on the model data of the main body structure, where the main body structure includes a first carrying region and a second carrying region. Specifically, the livestreaming management terminal 101 constructs the virtual screening room in the first carrying region based on the model data of the virtual screening room; and constructs the three-dimensional virtual sandbox in the second carrying region based on the model data of the three-dimensional virtual sandbox.

In some embodiments, based on the model data of the virtual screening room, the livestreaming management terminal 101 constructs a three-dimensional model of the virtual screening room in the first carrying region, and generates a model map of the virtual screening room; and pastes the model map of the virtual screening room on the three-dimensional model of the virtual screening room, to obtain the virtual screening room; and based on the model data of the three-dimensional virtual sandbox, constructs a three-dimensional model of the three-dimensional virtual sandbox in the second carrying region, and generates a model map of the three-dimensional virtual sandbox; and pastes the model map of the three-dimensional virtual sandbox on the three-dimensional model of the three-dimensional virtual sandbox, to obtain the three-dimensional virtual sandbox.

(3) Mark a location of the virtual object on the three-dimensional virtual sandbox based on the virtual object data of the current competition.

In some embodiments, the livestreaming management terminal 101 determines an initial location of the virtual object on the three-dimensional virtual sandbox based on the initial location information; and constructs the virtual object at the initial location based on the model data of the virtual object. Alternatively, the livestreaming management terminal 101 determines an initial location of the virtual object on the three-dimensional virtual sandbox based on the initial location information; and displays an identifier of the virtual object at the initial location based on the identification information of the virtual object.

In some embodiments, the livestreaming management terminal 101 further obtains competition data of the current competition during the competition; and performs at least one of the following operations based on the competition data.
1. Determine, based on the competition data, a target action needed to be performed by the virtual object, and control the virtual object to perform the target action on the three-dimensional virtual sandbox, where the target action includes at least one of an attack action, a movement action, a performance action, a virtual equipment switch action, and an observation action of the virtual object. Alternatively,
2. Determine a target movement path of the virtual object based on the competition data, and control the identifier of the virtual object to move on the three-dimensional virtual sandbox according to the target movement path. Alternatively,
3. Determine, based on the competition data, an event in which the virtual object defeats an adversary, and display, above the three-dimensional virtual sandbox, prompt information that the virtual object defeats the adversary. Alternatively,
4. Determine, based on the competition data, an event in which the virtual object is defeated by an adversary, and display, above the three-dimensional virtual sandbox, prompt information that the virtual object is defeated by the adversary. Alternatively,
5. When the competition data includes an event in which the virtual object defeats an adversary, generate, based on a facial close-up of a participant player, an expression associated with joy; and display the expression associated with joy above the virtual object or above the identifier of the virtual object. Alternatively,
6. When the competition data includes an event in which the virtual object is defeated by an adversary, generate, based on a facial close-up of a participant player, an expression associated with frustration; and display the expression associated with frustration above the virtual object or above the identifier of the virtual object. Alternatively,
7. Update a length of a health bar based on the competition data, where the health bar is displayed above the virtual object or above the identifier of the virtual object, and the health bar is configured for indicating a remaining health value of the virtual object.

(4) Play the first livestreaming video in the virtual screening room.

In some embodiments, a first player container is arranged in the virtual screening room; and the livestreaming management terminal 101 displays the first livestreaming video in the first player container.

Further, the livestreaming management terminal 101 further obtains a second livestreaming video of the current competition during the competition; and switches the first livestreaming video displayed in the first player container to the second livestreaming video, where the first livestreaming video and the second livestreaming video are livestreaming videos played consecutively.

In some embodiments, the livestreaming management terminal 101 further captures a three-dimensional full field-of-view picture of the three-dimensional virtual venue by using a first virtual camera, to generate a first video stream; and pushes the first video stream to the viewer terminal 102.

In conclusion, in the virtual venue display method in this embodiment of this application, through combination of the three-dimensional virtual sandbox and the virtual screening room, the viewer can subsequently see a battle situation of the virtual object and a battle situation of the participant player more three-dimensionally and vividly.

Exemplarily, during livestreaming of the competition, a user views the livestreaming on the viewer terminal 102. A process of performing the virtual venue display method by the viewer terminal 102 is as follows:

(1) Obtain the first video stream.

The viewer terminal 102 enters a first virtual livestreaming room, and obtains the first video stream after stream pulling. The stream pulling is a process of pulling the first video stream.

(2) Parse the first video stream to obtain the three-dimensional full field-of-view picture of the three-dimensional virtual venue.

The three-dimensional virtual venue includes the three-dimensional virtual sandbox and the virtual screening room. The three-dimensional virtual sandbox is configured for restoring a three-dimensional virtual environment in which the virtual object is located, and the virtual screening room is configured for livestreaming a competition event of the participant player.

(3) Display the three-dimensional full field-of-view picture corresponding to the first video stream on a hemispherical body; or display the three-dimensional full field-of-view picture corresponding to the first video stream on a spherical body.

Exemplarily, if the three-dimensional full field-of-view picture is a picture captured within a field-of-view range of horizontal 360 degrees and vertical 180 degrees, the viewer terminal 102 displays the three-dimensional full field-of-view picture corresponding to the first video stream on the hemispherical body. If the three-dimensional full field-of-view picture is a picture captured within a field-of-view range of horizontal 360 degrees and vertical 360 degrees, the viewer terminal 102 displays the three-dimensional full field-of-view picture corresponding to the first video stream on the spherical body.

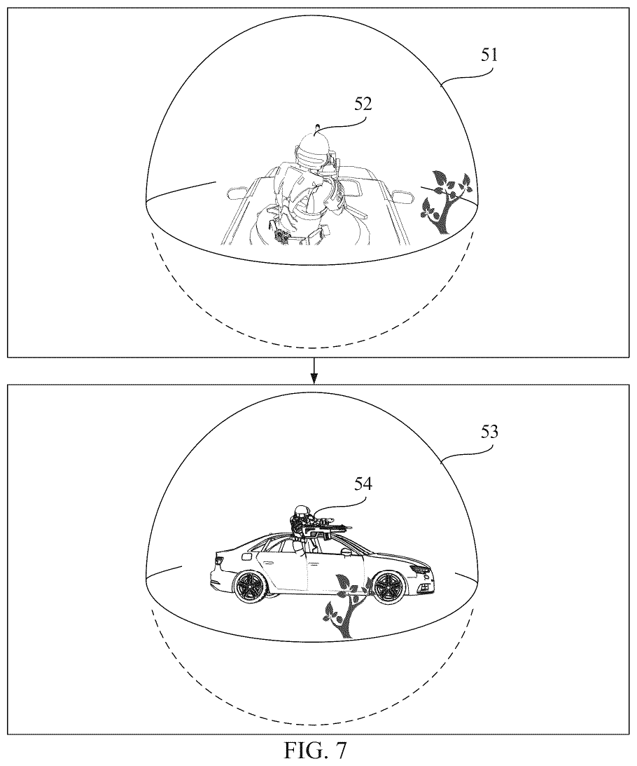

Exemplarily, an example in which the three-dimensional full field-of-view picture is the picture captured within the field-of-view range of horizontal 360 degrees and vertical 360 degrees, and the viewer terminal 102 displays the three-dimensional full field-of-view picture corresponding to the first video stream on the spherical body is used. As shown in FIG. 7, the viewer terminal 102 displays a three-dimensional full field-of-view picture 52 corresponding to the first video stream on a spherical body 51. The user can view livestreaming of the current competition by viewing the three-dimensional full field-of-view picture 52 on the spherical body 51. In addition, the user may further adjust an angle and a location of the spherical body 51. When the angle of the spherical body 51 is adjusted to a spherical body 53, the spherical body 53 displays a three-dimensional full field-of-view picture 54 at another angle. Based on this, the user can autonomously adjust a viewing angle and view the livestreaming of the current competition in an immersive manner.

In some embodiments, while the livestreaming video is displayed on a user interface of the viewer terminal 102, the user interface further includes a plurality of UI controls. The plurality of UI controls include a second switch control; a virtual livestreaming room is switched to a second virtual livestreaming room in response to a trigger operation on the second switch control; a second video stream is pulled; and the second video stream is parsed to obtain a three-dimensional full field-of-view picture of the three-dimensional virtual sandbox.

The plurality of UI controls include a third switch control; a virtual livestreaming room is switched to a third virtual livestreaming room in response to a trigger operation on the third switch control; a third video stream is pulled; and the third video stream is parsed to obtain a three-dimensional full field-of-view picture of the virtual screening room.

The plurality of UI controls include a first switch control; a virtual livestreaming room is switched to the first virtual livestreaming room in response to a trigger operation on the first switch control; the first video stream is pulled; and the first video stream is parsed to obtain the three-dimensional full field-of-view picture of the three-dimensional virtual venue.

The plurality of UI controls further include a scale control; and the livestreaming video is scaled in response to a scaling operation on the scale control.

The plurality of UI controls further include a field-of-view adjust control; and a direction of viewing the livestreaming video is adjusted in response to an adjustment operation triggered on the field-of-view adjust control. The livestreaming video is the three-dimensional full field-of-view picture obtained from the video stream.

The video stream in this application is an AR video stream or a VR video stream. The viewer terminal 102 may be a VR head-mounted device, a player, or the like.

In conclusion, in the virtual venue display method in this embodiment of this application, the user may view the livestreaming video of the entire virtual venue, and may view a scenario in the virtual venue at different angles through adjustment of a viewing field-of-view. This brings the user an immersive feeling of viewing the competition on site.

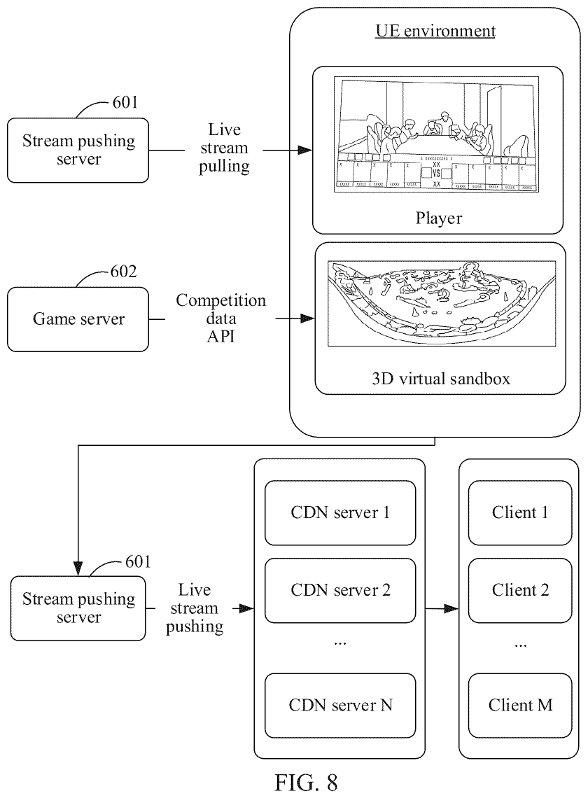

FIG. 8 is a schematic diagram of a process of livestreaming of a competition according to an exemplary embodiment of this application. A virtual object is a hero role in a current competition. A game server 602 includes behavior data and attribute data of all hero roles in the competition. After the livestreaming starts, a stream pushing server 601 in FIG. 8 inputs competition picture data (including picture data of a virtual venue and data of an on-site livestreaming video of the competition) from a field-of-view of a broadcast director into a UE model, and the game server 602 continuously inputs competition data (the behavior data and attribute data of all hero roles) into the UE model. The UE model dynamically updates a hero avatar location on a 3D virtual sandbox in a virtual livestreaming room based on a location of the hero role. The UE model updates a picture presented in a player container in a virtual screening room based on the competition picture data (namely, livestreaming video data). The virtual venue is a VR virtual venue constructed through 3D modeling. Picture data of the synthesized VR virtual venue is pushed to a viewer client through the stream pushing server 601 for playback. Picture data of the virtual livestreaming room transmitted by the stream pushing server 601 is forwarded to M clients through a content delivery network (CDN) service provided by N CDN manufacturers, where N and M are positive integers.

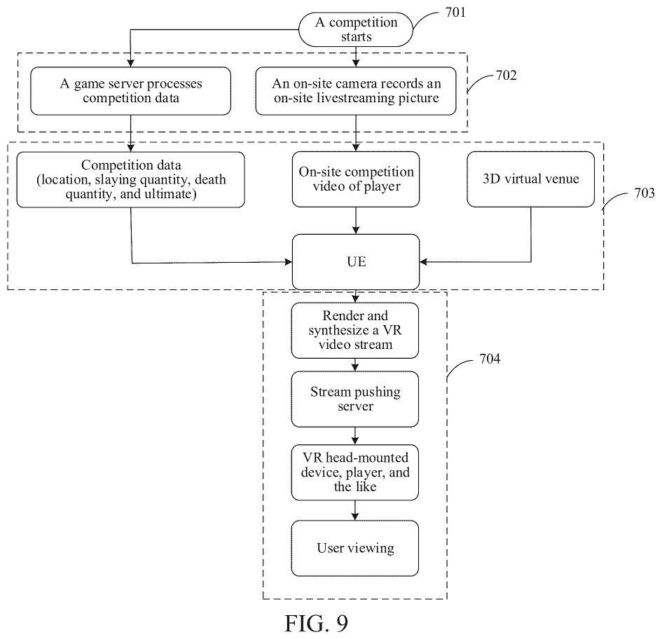

FIG. 9 is a flowchart of a method for livestreaming of a competition according to an exemplary embodiment of this application.

Operation 701: A competition starts.

A livestreaming device is set up at a competition site, official livestreaming of the competition is started, a competition team enters a competition state, and a venue is cleared of irrelevant personnel.

Operation 702: A game server processes competition data; and an on-site camera records an on-site livestreaming video.

The livestreaming device includes a broadcast camera, and the broadcast camera starts to capture a picture for a network user, in other words, to capture a picture of a participant player during the competition.

During a battle, competition data of a game role controlled by the participant player is transmitted to the game server. The competition data includes a location of the game role, economic information, equipment information, skill usage, a survival status, and a game picture from a field-of-view of the player, and the like.

Operation 703: Input competition data, a video of a player at a competition site, and data of a 3D virtual venue into an unreal engine.

The competition data obtained after processing by the game server, the video of the player at the competition site obtained through recording by the on-site camera, and the data of the 3D virtual venue are inputted into the UE. In other words, after the competition starts, the on-site livestreaming video is captured by the broadcast camera and is transmitted to the UE in real time; and the competition data is also inputted into the ULE after being processed by the game server. The data of the 3D virtual venue is further obtained, and is inputted into the UE.

The UE fills a real-time picture into a player container in the 3D virtual venue, displays the competition data on a competition data dashboard, and inputs a location movement path of a hero character into a 3D sandbox, so that the 3D virtual venue and a site of the livestreaming of the competition are linked together, and a user can view a more realistic competition in an immersive environment.

A 3D model of the sandbox may be designed according to a product requirement. The 3D model includes a texture, a static mesh, a skeletal animation, coordinates, and the like, and is packed into a sandbox model file.

A developer imports a sandbox model into a UE model project of the virtual venue. The developer writes blueprint script codes. The codes are configured for processing competition data, such as location coordinate data and health value data, inputted from the outside. The developer can further design a health bar displaying a health value of a role, an avatar texture, and the like. The blueprint script codes dynamically update a location of a role on a three-dimensional virtual sandbox based on real-time competition data. A refresh rate is about 10 times per second, and movement of the role in the competition is restored.

Operation 704: Render and synthesize a VR video stream, and push the stream to a client.

In a three-dimensional virtual venue (including a virtual esports venue) of the UE, a virtual camera with a third-person field-of-view is added. The virtual camera collects all model data of the entire venue, renders and synthesizes the VR video stream, and encodes the VR video stream into a real time messaging protocol (RTMP) video stream after conversion through an “off world live” plug-in. Subsequently, the video stream is transmitted to a stream pushing server through a network device interface (NDI) transmission protocol. After obtaining a video stream address for livestreaming, the client requests a server to pull the video stream. After the client obtains data after pulling, the data is locally decoded. Audio and a video are synchronized, and are then rendered on a spherical body. The user views the spherical body, and adjusts an angle and a location, to view a competition video immersively.

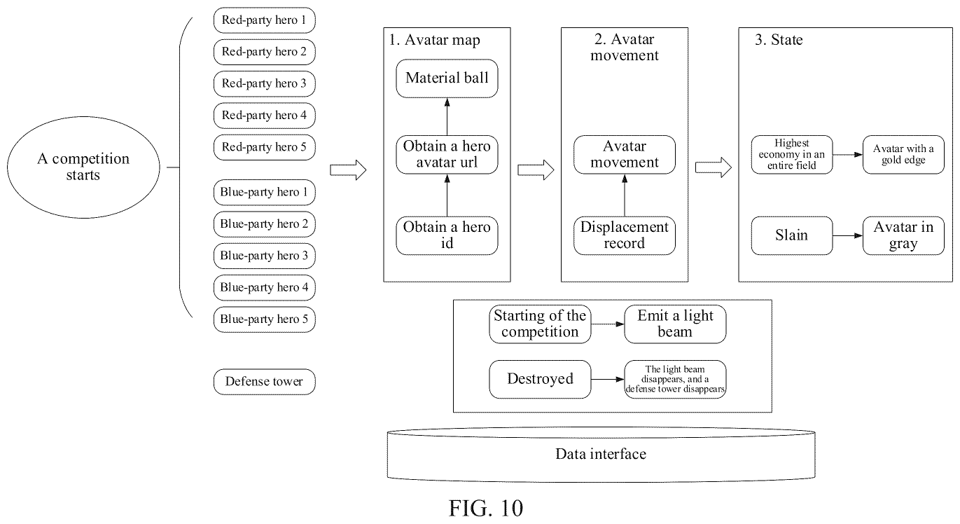

FIG. 10 is a schematic diagram of competition data processing according to an exemplary embodiment of this application. After a competition starts, a role character controlled by a participant player generates a series of competition data. Two camps are distinguished by red and blue. An avatar map is a hero id transmitted through the competition data, and a network address for a corresponding hero figure is found. After being downloaded, the figure is converted into a material ball by using a UE, and the UE renders the material ball on a VR picture (3D virtual sandbox) during running. The competition data includes location coordinates of the role character, and a complete role location path may be finally formed by using a series of discrete coordinate data. Based on a design of a blueprint script, the UE updates a location of a role on the 3D virtual sandbox based on the competition data, and when an update frequency is fast enough, a consecutive location movement effect may be achieved. Death data and victory data of the role on a field may be reflected through colors of an avatar. If the role wins, the UE performs rendering to obtain an avatar added with a gold edge. If the role dies, the avatar is displayed in gray.

In a competition livestreaming method in the embodiments of this application, a real scene picture is integrated into a 3D scenario by using a VR virtual rendering capability, to form mixed reality. In this way, an immersive feeling of viewing a competition on site can be achieved, and more virtual objects may be created by using divergence of virtual modeling. Moreover, a game character is deeply duplicated and restored into a virtual scenario, allowing a VR viewer to see activities such as movement, equipment, and an attack of a hero more three-dimensionally and vividly.

FIG. 11 is a block diagram of an apparatus for generating a virtual venue according to an exemplary embodiment of this application. The apparatus includes:
an obtaining module 801, configured to obtain model data of a three-dimensional virtual venue, virtual object data of a current competition, and a first livestreaming video;
a constructing module 802, configured to construct the three-dimensional virtual venue based on the model data of the three-dimensional virtual venue, the three-dimensional virtual venue including a three-dimensional virtual sandbox and a virtual screening room, the three-dimensional virtual sandbox being configured for restoring a three-dimensional virtual environment in which a virtual object is located, and the virtual screening room being configured for livestreaming a competition event of a participant player; and
the constructing module 802 being further configured to mark a location of the virtual object on the three-dimensional virtual sandbox based on the virtual object data of the current competition; and
a playing module 803, configured to play the first livestreaming video in the virtual screening room, the first livestreaming video being a picture for livestreaming the current competition.

In some embodiments, the model data of the three-dimensional virtual venue includes at least one of model data of a main body structure, model data of the virtual screening room, and model data of the three-dimensional virtual sandbox; and
the constructing module 802 is configured to:
construct the main body structure of the three-dimensional virtual venue based on the model data of the main body structure, where the main body structure includes a first carrying region and a second carrying region;
construct the virtual screening room in the first carrying region based on the model data of the virtual screening room; and construct the three-dimensional virtual sandbox in the second carrying region based on the model data of the three-dimensional virtual sandbox.

In some embodiments, the constructing module 802 is configured to:
based on the model data of the virtual screening room, construct a three-dimensional model of the virtual screening room in the first carrying region, and generate a model map of the virtual screening room; and paste the model map of the virtual screening room on the three-dimensional model of the virtual screening room, to obtain the virtual screening room; and
based on the model data of the three-dimensional virtual sandbox, construct a three-dimensional model of the three-dimensional virtual sandbox in the second carrying region, and generate a model map of the three-dimensional virtual sandbox; and paste the model map of the three-dimensional virtual sandbox on the three-dimensional model of the three-dimensional virtual sandbox, to obtain the three-dimensional virtual sandbox.

In some embodiments, the virtual object data of the current competition includes: at least one of model data of the virtual object and initial location information; and
the constructing module 802 is configured to:
determine an initial location of the virtual object on the three-dimensional virtual sandbox based on the initial location information; and
construct the virtual object at the initial location based on the model data of the virtual object.

In some embodiments, the apparatus further includes an update module 804;
the obtaining module 801 is configured to obtain competition data of the current competition during the competition; and
the update module 804 is configured to determine, based on the competition data, a target action needed to be performed by the virtual object, and control the virtual object to perform the target action on the three-dimensional virtual sandbox, where
the target action includes at least one of an attack action, a movement action, a performance action, a virtual equipment switch action, and an observation action of the virtual object.

In some embodiments, the virtual object data of the current competition includes: at least one of identification information of the virtual object and initial location information; and
the constructing module 802 is configured to:
determine an initial location of the virtual object on the three-dimensional virtual sandbox based on the initial location information; and
display an identifier of the virtual object at the initial location based on the identification information of the virtual object.

In some embodiments, the apparatus further includes an update module 804;
the obtaining module 801 is configured to obtain competition data of the current competition during the competition; and
the update module 804 is configured to determine a target movement path of the virtual object based on the competition data, and control the identifier of the virtual object to move on the three-dimensional virtual sandbox according to the target movement path.

In some embodiments, the update module 804 is configured to:
determine, based on the competition data, an event in which the virtual object defeats an adversary, and display, above the three-dimensional virtual sandbox, prompt information that the virtual object defeats the adversary; or
determine, based on the competition data, an event in which the virtual object is defeated by an adversary, and display, above the three-dimensional virtual sandbox, prompt information that the virtual object is defeated by the adversary.

In some embodiments, the competition data further includes: at least one of an event in which the virtual object defeats an adversary or an event in which the virtual object is defeated by an adversary, and a facial close-up of the participant player controlling the virtual object; and
the update module 804 is configured to:
when the competition data includes the event in which the virtual object defeats an adversary, generate, based on the facial close-up of the participant player, an expression associated with joy; and display the expression associated with joy above the virtual object or above the identifier of the virtual object; or
when the competition data includes the event in which the virtual object is defeated by an adversary, generate, based on the facial close-up of the participant player, an expression associated with frustration; and display the expression associated with frustration above the virtual object or above the identifier of the virtual object.

In some embodiments, a health bar is displayed above the virtual object or above the identifier of the virtual object, and the health bar is configured for indicating a remaining health value of the virtual object; and
the update module 804 is configured to:
update a length of the health bar based on the competition data.

In some embodiments, a first player container is arranged in the virtual screening room; and
the playing module 803 is configured to display the first livestreaming video in the first player container.

In some embodiments,
the obtaining module 801 is configured to obtain a second livestreaming video of the current competition during the competition; and
the playing module 803 is configured to switch the first livestreaming video displayed in the first player container to the second livestreaming video, where the first livestreaming video and the second livestreaming video are livestreaming videos played consecutively.

In some embodiments, at least two second player containers are arranged in the virtual screening room; and
the playing module 803 is configured to display an image of a virtual object used by each participant player in each second player container.

In some embodiments, the apparatus further includes a stream pushing module 805; and
the stream pushing module 805 is configured to capture a three-dimensional full field-of-view picture of the three-dimensional virtual venue by using a first virtual camera, to generate a first video stream; and push the first video stream, where
the three-dimensional full field-of-view picture is a picture captured from the three-dimensional virtual venue within a field-of-view range of a first horizontal angle and a first vertical angle, the first horizontal angle includes horizontal 360 degrees, and the first vertical angle includes vertical 180 degrees.

In some embodiments,
the stream pushing module 805 is configured to capture, by using a second virtual camera, a three-dimensional full field-of-view picture of an event occurring on the three-dimensional virtual sandbox, to generate a second video stream; and push the second video stream, where
the three-dimensional full field-of-view picture is a picture captured from the three-dimensional virtual sandbox within a field-of-view range of a second horizontal angle and a second vertical angle, the second horizontal angle includes horizontal 360 degrees, and the second vertical angle includes vertical 180 degrees.

When the apparatus provided in the foregoing embodiments implements functions of the apparatus, it is illustrated with an example of division of each functional module. In actual application, the function distribution may be finished by different functional modules according to actual requirements. In other words, an internal structure of a device is divided into different functional modules, to implement all or some of the functions described above.

Specific manners of performing operations by the modules of the apparatus in the foregoing embodiment are already described in detail in the embodiments related to the method; and technical effects achieved by performing operations by the modules are the same as the technical effects in the embodiments related to the method, and details are not elaborated and described herein.

An embodiment of this application further provides a computer device, including a processor and a memory, the memory having at least one instruction, at least one segment of program, and a code set or an instruction set stored therein, the at least one instruction, the at least one segment of program, and the code set or the instruction set being loaded and executed by the processor to implement the method for generating a virtual venue provided in the foregoing method embodiments.

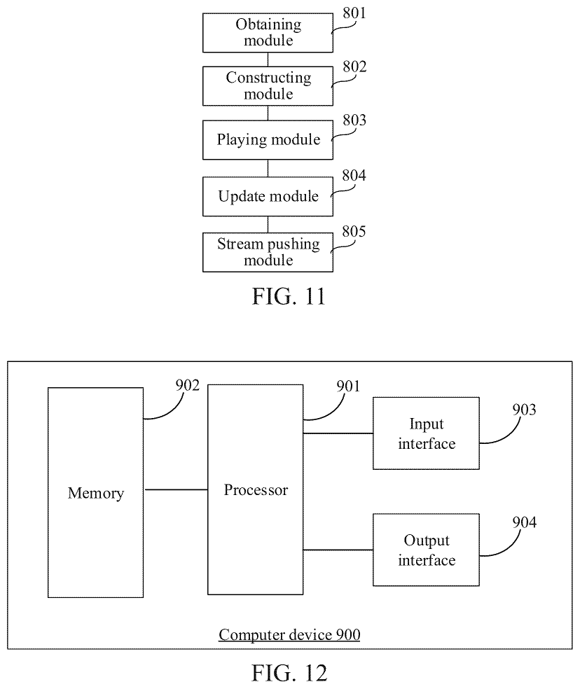

The computer device may be a terminal (such as a livestreaming management terminal or a viewer terminal) or a server. Exemplarily, FIG. 12 is a structural block diagram of a computer device according to an exemplary embodiment of this application.

Generally, a computer device 900 includes a processor 901 and a memory 902.

The processor 901 may include one or more processing cores, and may be, for example, a 4-core processor or an 8-core processor. The processor 901 may be implemented by using at least one hardware form of digital signal processing (DSP), a field-programmable gate array (FPGA), and a programmable logic array (PLA). The processor 901 may alternatively include a main processor and a coprocessor. The main processor is configured to process data in an active state, and is also referred to as a central processing unit (CPU); and the coprocessor is a low-power processor configured to process data in a standby state. In some embodiments, the processor 901 may be integrated with a graphics processing unit (GPU). The GPU is configured to render and draw content that needs to be displayed on a display screen. In some embodiments, the processor 901 may further include an artificial intelligence (AI) processor. The AI processor is configured to process computing operations related to machine learning.

The memory 902 may include one or more computer-readable storage media that may be non-transitory. The memory 902 may further include a high-speed random access memory and a non-volatile memory, for example, one or more disk storage devices or flash storage devices. In some embodiments, the non-transitory computer-readable storage medium in the memory 902 is configured to store at least one instruction. The at least one instruction is configured for being executed by the processor 901 to implement the method for generating a virtual venue provided in the method embodiments in this application.

In some embodiments, the computer device 900 may include: an input interface 903 and an output interface 904. The processor 901, the memory 902, the input interface 903, and the output interface 904 may be connected through a bus or a signal cable. Each peripheral may be connected to the input interface 903 and the output interface 904 through a bus, a signal cable, or a circuit board. The input interface 903 and the output interface 904 may be configured to connect at least one peripheral device related to input/output (I/O) to the processor 901 and the memory 902. In some embodiments, the processor 901, the memory 902, the input interface 903, and the output interface 904 are integrated on the same chip or the same circuit board. In some other embodiments, any one or two of the processor 901, the memory 902, the input interface 903, and the output interface 904 may be implemented on an independent chip or circuit board. This is not limited in the embodiments of this application.

A person skilled in the art may understand that the foregoing structure does not constitute any limitation on the computer device 900, and the computer device may include more components or fewer components than those shown in the figure, or some components may be combined, or a different component deployment may be used.

In an exemplary embodiment, a chip is further provided, including a programmable logic circuit and/or a program instruction, when running on a computer device, the chip being configured to implement the method for generating a virtual venue provided in the foregoing aspects.

In an exemplary embodiment, a computer program product or a computer program is provided. The computer program product or the computer program includes computer instructions, and the computer instructions are stored in a computer-readable storage medium. A processor of a computer device reads the computer instructions from the computer-readable storage medium and executes the computer instructions, to cause the computer device to perform the method for generating a virtual venue provided in the foregoing method embodiments.

In an exemplary embodiment, a non-transitory computer-readable storage medium is further provided, the computer-readable storage medium having at least one piece of program code stored therein, and the program code, when loaded and executed by a processor of a computer device, implementing the method for generating a virtual venue provided in the foregoing method embodiments.

A person of ordinary skill in the art may understand that all or part of the operations of implementing the foregoing embodiments may be implemented by hardware, or may be implemented by a program instructing related hardware. The program may be stored in a computer-readable storage medium. The foregoing storage medium may be a read-only memory, a magnetic disk, an optical disc, or the like.

A person skilled in the art is to aware that in the one or more examples, the functions described in the embodiments of this application may be implemented by using hardware, software, firmware, or any combination thereof. When implemented by using software, the functions can be stored in a computer-readable medium or can be used as one or more instructions or code in a computer-readable medium for transmission. The computer-readable medium includes a computer storage medium and a communications medium, where the communications medium includes any medium that enables a computer program to be transmitted from one place to another. The storage medium may be any available medium accessible to a general-purpose or dedicated computer.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for generating an immersive three-dimensional virtual venue performed by a computer device and the method comprising:
constructing a three-dimensional virtual venue, the three-dimensional virtual venue comprising a three-dimensional virtual sandbox and a virtual screening room, the three-dimensional virtual sandbox being a three-dimensional virtual environment in which a virtual object is located, and the virtual screening room being configured for livestreaming a player controlling the virtual object to participate a current competition in the three-dimensional virtual sandbox;
dynamically updating a location of the virtual object in the three-dimensional virtual sandbox based on an update to the current competition;
generating a first livestreaming video of the virtual object participating the current competition in the three-dimensional virtual sandbox by capturing a three-dimensional full field-of-view video of the virtual object in the three-dimensional virtual venue by using a first virtual camera; and
playing the first livestreaming video in the virtual screening room and pushing the first livestreaming video to a terminal associated with a virtual viewer in the virtual screening room.

2. The method according to claim 1, wherein the constructing the three-dimensional virtual venue comprises:
constructing a main body structure of the three-dimensional virtual venue, wherein the main body structure comprises a first carrying region and a second carrying region;
constructing the virtual screening room in the first carrying region; and
constructing the three-dimensional virtual sandbox in the second carrying region.

3. The method according to claim 2, wherein the constructing the virtual screening room in the first carrying region comprises:
constructing a three-dimensional model of the virtual screening room in the first carrying region, and generating a model map of the virtual screening room; and
pasting the model map of the virtual screening room on the three-dimensional model of the virtual screening room, to obtain the virtual screening room; and
the constructing the three-dimensional virtual sandbox in the second carrying region comprises:
constructing a three-dimensional model of the three-dimensional virtual sandbox in the second carrying region, and generating a model map of the three-dimensional virtual sandbox; and
pasting the model map of the three-dimensional virtual sandbox on the three-dimensional model of the three-dimensional virtual sandbox, to obtain the three-dimensional virtual sandbox.

4. The method according to claim 1, wherein the dynamically updating a location of the virtual object in the three-dimensional virtual sandbox based on an update to the current competition comprises:
determining an initial location of the virtual object in the three-dimensional virtual sandbox;
constructing the virtual object at the initial location in the three-dimensional virtual sandbox;
obtaining live competition data of the current competition; and
controlling the virtual object to perform a target action in the three-dimensional virtual sandbox based on the live competition data of the current competition, wherein
the target action comprises at least one of an attack action, a movement action, a performance action, a virtual equipment switch action, and an observation action of the virtual object.

5. The method according to claim 1, wherein the dynamically updating a location of the virtual object in the three-dimensional virtual sandbox based on an update to the current competition comprises:
determining an initial location of the virtual object in the three-dimensional virtual sandbox;
displaying an identifier of the virtual object at the initial location in the three-dimensional virtual sandbox;
obtaining live competition data of the current competition; and
controlling the identifier of the virtual object to move in the three-dimensional virtual sandbox according to a target movement path based on the live competition data of the current competition.

6. The method according to claim 1, wherein a first player container is arranged in the virtual screening room; and
the playing the first livestreaming video in the virtual screening room comprises:
displaying the first livestreaming video in the first player container.

7. The method according to claim 6, wherein the method further comprises:
obtaining a second livestreaming video of the current competition; and
switching the first livestreaming video displayed in the first player container to the second livestreaming video.

8. The method according to claim 1, wherein the three-dimensional full field-of-view video is captured from the three-dimensional virtual venue within a field-of-view range of a first horizontal angle and a first vertical angle.

9. The method according to claim 1, wherein the method further comprises:
capturing a three-dimensional full field-of-view video of the three-dimensional virtual sandbox by using a second virtual camera, to generate a second livestreaming video; and
pushing the second livestreaming video together with the first the first livestreaming video to the terminal associated with the virtual viewer in the virtual screening room.

10. A computer device, comprising: a processor and a memory, the memory having executable instructions stored therein; and the processor being configured to execute the executable instructions in the memory, to implement a method for generating an immersive three-dimensional virtual venue including:
constructing a three-dimensional virtual venue, the three-dimensional virtual venue comprising a three-dimensional virtual sandbox and a virtual screening room, the three-dimensional virtual sandbox being a three-dimensional virtual environment in which a virtual object is located, and the virtual screening room being configured for livestreaming a player controlling the virtual object to participate a current competition in the three-dimensional virtual sandbox;
dynamically updating a location of the virtual object in the three-dimensional virtual sandbox based on an update to the current competition;
generating a first livestreaming video of the virtual object participating the current competition in the three-dimensional virtual sandbox by capturing a three-dimensional full field-of-view video of the virtual object in the three-dimensional virtual venue by using a first virtual camera; and
playing the first livestreaming video in the virtual screening room and pushing the first livestreaming video to a terminal associated with a virtual viewer in the virtual screening room.

11. The computer device according to claim 10, wherein the constructing the three-dimensional virtual venue comprises:
constructing a main body structure of the three-dimensional virtual venue, wherein the main body structure comprises a first carrying region and a second carrying region;
constructing the virtual screening room in the first carrying region; and
constructing the three-dimensional virtual sandbox in the second carrying region.

12. The computer device according to claim 11, wherein the constructing the virtual screening room in the first carrying region comprises:
constructing a three-dimensional model of the virtual screening room in the first carrying region, and generating a model map of the virtual screening room; and
pasting the model map of the virtual screening room on the three-dimensional model of the virtual screening room, to obtain the virtual screening room; and
the constructing the three-dimensional virtual sandbox in the second carrying region comprises:
constructing a three-dimensional model of the three-dimensional virtual sandbox in the second carrying region, and generating a model map of the three-dimensional virtual sandbox; and
pasting the model map of the three-dimensional virtual sandbox on the three-dimensional model of the three-dimensional virtual sandbox, to obtain the three-dimensional virtual sandbox.

13. The computer device according to claim 10, wherein the dynamically updating a location of the virtual object in the three-dimensional virtual sandbox based on an update to the current competition comprises:
determining an initial location of the virtual object in the three-dimensional virtual sandbox;
constructing the virtual object at the initial location in the three-dimensional virtual sandbox;
obtaining live competition data of the current competition; and
controlling the virtual object to perform a target action in the three-dimensional virtual sandbox based on the live competition data of the current competition, wherein
the target action comprises at least one of an attack action, a movement action, a performance action, a virtual equipment switch action, and an observation action of the virtual object.

14. The computer device according to claim 10, wherein the dynamically updating a location of the virtual object in the three-dimensional virtual sandbox based on an update to the current competition comprises:
determining an initial location of the virtual object in the three-dimensional virtual sandbox;
displaying an identifier of the virtual object at the initial location in the three-dimensional virtual sandbox;
obtaining live competition data of the current competition; and
controlling the identifier of the virtual object to move in the three-dimensional virtual sandbox according to a target movement path based on the live competition data of the current competition.

15. The computer device according to claim 10, wherein a first player container is arranged in the virtual screening room; and
the playing the first livestreaming video in the virtual screening room comprises:
displaying the first livestreaming video in the first player container.

16. The computer device according to claim 15, wherein the method further comprises:
obtaining a second livestreaming video of the current competition; and
switching the first livestreaming video displayed in the first player container to the second livestreaming video.

17. The computer device according to claim 10, wherein the three-dimensional full field-of-view video is captured from the three-dimensional virtual venue within a field-of-view range of a first horizontal angle and a first vertical angle.

18. The computer device according to claim 10, wherein the method further comprises:
capturing a three-dimensional full field-of-view video of the three-dimensional virtual sandbox by using a second virtual camera, to generate a second livestreaming video; and
pushing the second livestreaming video together with the first the first livestreaming video to the terminal associated with the virtual viewer in the virtual screening room.

19. A non-transitory computer-readable storage medium, having executable instructions stored therein, the executable instructions being loaded and executed by a processor of a computer device to implement a method for generating an immersive three-dimensional virtual venue including:
constructing a three-dimensional virtual venue, the three-dimensional virtual venue comprising a three-dimensional virtual sandbox and a virtual screening room, the three-dimensional virtual sandbox being a three-dimensional virtual environment in which a virtual object is located, and the virtual screening room being configured for livestreaming a player controlling the virtual object to participate a current competition in the three-dimensional virtual sandbox;
dynamically updating a location of the virtual object in the three-dimensional virtual sandbox based on an update to the current competition;
generating a first livestreaming video of the virtual object participating the current competition in the three-dimensional virtual sandbox by capturing a three-dimensional full field-of-view video of the virtual object in the three-dimensional virtual venue by using a first virtual camera; and
playing the first livestreaming video in the virtual screening room and pushing the first livestreaming video to a terminal associated with a virtual viewer in the virtual screening room.

20. The non-transitory computer-readable storage medium according to claim 19, wherein the method further comprises:
capturing a three-dimensional full field-of-view video of the three-dimensional virtual sandbox by using a second virtual camera, to generate a second livestreaming video; and
pushing the second livestreaming video together with the first the first livestreaming video to the terminal associated with the virtual viewer in the virtual screening room.
